(19) United States
(12) Patent Application Publication
(10) Pub. No.: US 2024/0101158 A1
(43) Pub. Date: Mar. 28, 2024

(54) DETERMINING A LOCATION OF A TARGET VEHICLE RELATIVE TO A LANE

(71) Applicant: QUALCOMM Incorporated, San Diego, CA (US)

(72) Inventors: Shivam AGARWAL, Sunnyvale, CA (US); Avdhut JOSHI, San Marcos, CA (US); Jayakrishnan UNNIKRISHNAN, Bellevue, WA (US); Yoga Y NADARAAJAN, Poway, CA (US); Sree Sesha Aravind VADREVU, San Diego, CA (US); Gautam SACHDEVA, San Diego, CA (US)

(21) Appl. No.: 18/336,840

(22) Filed: Jun. 16, 2023

Related U.S. Application Data
(60) Provisional application No. 63/376,256, filed on Sep. 19, 2022.

(51) Int. Cl. B60W 60/00

(52) U.S. Cl. CPC B60W 60/0027; B60W 2420/42; B60W 2554/4041

(57) ABSTRACT

Systems and techniques are described herein for determining at least one location of at least one target vehicle relative to a lane. For instance, a method for determining at least one location of at least one target vehicle relative to a lane is provided. The method may include obtaining a position of a target vehicle within an image; obtaining one or more positions of a lane boundary within the image; determining a distance between the target vehicle and the lane boundary based on the position of the target vehicle within the image and the one or more positions of the lane boundary within the image; and adjusting a position of the target vehicle in a map based on the distance between the target vehicle and the lane boundary and a position of the lane boundary in the map

### CROSS-REFERENCED TO REPLATED APPLICATIONS

This application claims the benefit of U.S. Provisional Application No. 63/376,256, filed on Sep. 19, 2022, which is incorporated herein by reference in its entirety.

### TECHNICAL FIELD

The present disclosure generally relates to determining a location of a target vehicle relative to a lane. For example, aspects of the present disclosure include systems and techniques for obtaining an image of a target vehicle and a lane boundary and determining a location of the target vehicle relative to the lane boundary based on the image.

### BACKGROUND

Object detection can be used to identify objects (e.g., from a digital image or a video frame of a video clip). Object tracking can be used to track a detected object over time. Object detection and tracking can be used in different fields, including autonomous driving, video analytics, security systems, robotics, aviation, among many others. In some fields, a tracking object can determine positions of target objects in an environment so that the tracking object can accurately navigate through the environment (e.g., to make accurate motion planning and trajectory planning decisions).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining at least one location of at least one target vehicle relative to a lane, the method comprising. According to at least one example, a method is provided for determining at least one location of at least one target vehicle relative to a lane, the method comprising. The method includes: obtaining a position of a target vehicle within an image; obtaining one or more positions of a lane boundary within the image; determining a distance between the target vehicle and the lane boundary based on the position of the target vehicle within the image and the one or more positions of the lane boundary within the image; and adjusting a position of the target vehicle in a map based on the distance between the target vehicle and the lane boundary and a position of the lane boundary in the map.

In another example, an apparatus for determining at least one location of at least one target vehicle relative to a lane, the method comprising is provided that includes at least one memory and at least one processor (e.g., configured in circuitry) coupled to the at least one memory. The at least one processor configured to: obtain a position of a target vehicle within an image; obtain one or more positions of a lane boundary within the image; determine a distance between the target vehicle and the lane boundary based on the position of the target vehicle within the image and the one or more positions of the lane boundary within the image; and adjust a position of the target vehicle in a map based on the distance between the target vehicle and the lane boundary and a position of the lane boundary in the map.

In another example, a non-transitory computer-readable medium is provided that has stored thereon instructions that, when executed by one or more processors, cause the one or more processors to: obtain a position of a target vehicle within an image; obtain one or more positions of a lane boundary within the image; determine a distance between the target vehicle and the lane boundary based on the position of the target vehicle within the image and the one or more positions of the lane boundary within the image; and adjust a position of the target vehicle in a map based on the distance between the target vehicle and the lane boundary and a position of the lane boundary in the map.

In another example, an apparatus for determining at least one location of at least one target vehicle relative to a lane, the method comprising is provided. The apparatus includes: means for obtaining a position of a target vehicle within an image; means for obtaining one or more positions of a lane boundary within the image; means for determining a distance between the target vehicle and the lane boundary based on the position of the target vehicle within the image and the one or more positions of the lane boundary within the image; and means for adjusting a position of the target vehicle in a map based on the distance between the target vehicle and the lane boundary and a position of the lane boundary in the map.

In some aspects, one or more of the apparatuses described herein is, can be part of, or can include a vehicle (or a computing device or system of a vehicle), a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating vehicles driving on a road, including a tracking vehicle which may track others of the vehicles, according to various aspects of the present disclosure;

FIG. 2A is a representation of an example image captured by a camera of a tracking vehicle;

FIG. 2B is a diagram illustrating a bird's eye view of an environment of the tracking vehicle;

FIG. 3 is a diagram illustrating an example of adjusting a location of a target vehicle in an internal map based on a relationship between a lane boundary and the target vehicle in an image, according to various aspects of the present disclosure;

FIG. 4 is a diagram illustrating data points arranged in an image plane that may be used to determine a location of a target vehicle relative to a lane boundary, according to various aspects of the present disclosure;

FIG. 5A is a diagram illustrating a top view of one of the bounding boxes of FIG. 4 and a projected lane boundary to provide context for a description of an example process for determining a lateral offset between a vehicle and a lane boundary according to various aspects of the present disclosure;

FIG. 5B is a diagram illustrating a side view of the bounding box of FIG. 5A and a ground plane to provide context for the description of the example process for determining a lateral offset between a vehicle and a lane boundary according to various aspects of the present disclosure;

FIG. 6 is a flow diagram illustrating a process for determining a location of a target vehicle in relation to a lane boundary, in accordance with aspects of the present disclosure;

FIG. 7 is a diagram illustrating an example of a deep learning neural network that can be used to implement a perception module and/or one or more validation modules, according to some aspects of the disclosed technology;

FIG. 8 is a diagram illustrating an example of a convolutional neural network (CNN), according to various aspects of the present disclosure; and

FIG. 9 is a diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Object detection and tracking can be used to identify an object and track the object over time. For example, an image of an object can be obtained, and object detection can be performed on the image to detect one or more objects in the image. In some cases, the detected object can be classified into a category of object and a bounding box can be generated to identify a position of the object in the image. Various types of systems can be used for object detection, including neural network-based object detectors.

Object detection and tracking can be used in autonomous driving systems, video analytics, security systems, robotics systems, aviation systems, among others systems. In such systems, an object (referred to as a tracking object) can track other objects (referred to as target objects) in an environment and determine positions and sizes of the other objects. Determining the locations, orientations, sizes, and/or other characteristics of target objects in the environment allows the tracking object to accurately navigate through the environment by making intelligent motion planning and trajectory planning decisions. However, it can be difficult to accurately identify such characteristics of the target object.

One example of a field where a tracking object needs to be able to determine characteristics (e.g., location, orientation, size, etc.) of target objects is autonomous or semi-autonomous driving by autonomous/semi-autonomous driving systems (e.g., of autonomous vehicles). In such cases, a tracking object can be a vehicle and a target object can be another vehicle, a lane on a road, an object on a road (e.g., a cone, a median, etc.), and/or other object. An important goal of autonomous driving systems is the ability of an autonomous vehicle to detect and track other vehicles and objects around the autonomous vehicle. This can become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain at the in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles full autonomous, self-driving vehicles that operate autonomously in all conditions. A human operator is not needed for the vehicle to take any action. In the present disclosure, the term “autonomous driving system” may refer to any level of autonomous driving system, including advanced driver assistance systems (ADAS). Additionally, in the present disclosure, the term “autonomous vehicle” or “autonomous system” may refer to a vehicle or system with any level of autonomy, including semi-autonomous autonomous vehicles.

Various aspects of the application will be described with respect to the figures below.

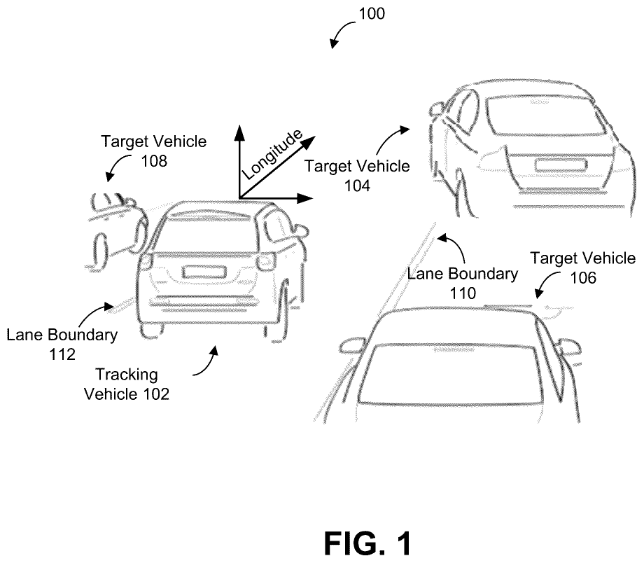

FIG. 1 is a diagram illustrating vehicles driving on a road, including a tracking vehicle 102 which may track others of the vehicles, according to various aspects of the present disclosure. The vehicles include a tracking vehicle 102, a target vehicle 104, a target vehicle 106, and a target vehicle 108. The road is divided into lanes marked by lane boundary 110 and lane boundary 112 (e.g., among others not illustrated in FIG. 1). Tracking vehicle 102 may be an autonomous or semi-autonomous vehicle operating at any autonomy level. Tracking vehicle 102 may track the target vehicle 104, target vehicle 106, target vehicle 108, lane boundary 110 and/or lane boundary 112 in order to navigate in environment 100. For example, tracking vehicle 102 can track target vehicle 104 and/or one or more lanes (or other road objects) in which tracking vehicle 102 is driving to determine when to slow down, speed up, change lanes, and/or perform some other function. While tracking vehicle 102 is referred to as a tracking vehicle 102 and the target vehicle 104, target vehicle 106, and target vehicle 108 are referred to as target vehicles with respect to FIG. 1, the target vehicle 104, target vehicle 106, and target vehicle 108 can also be referred to as tracking vehicles if and when they are tracking other vehicles, in which the other vehicles become target vehicles.

It may be useful to track target vehicles relative to lanes. For example, to track target vehicle 104, target vehicle 106, and/or target vehicle 108 and/or to plan movements, tracking vehicle 102 may determine where each of target vehicle 104, target vehicle 106, and target vehicle 108 are in relation to lane boundary 110 and/or lane boundary 112. For example, it may be useful for tracking vehicle 102 to determine where target vehicle 104 is in relation to lane boundary 110. For example, determining where target vehicle 104 is relative to lane boundary 110 may aid tracking vehicle 102 in determining whether target vehicle 104 is entering a lane of tracking vehicle 102.

According to some techniques, to determine locations of target vehicles in relation to lanes, tracking vehicle 102 may determine locations of target vehicles and determine locations of lanes. Tracking vehicle 102 may track target vehicle 104, target vehicle 106, and/or target vehicle 108 using perception techniques. Examples of such perception techniques include image-based techniques based on images captured by cameras of tracking vehicle 102, radio detection and ranging (RADAR)-based techniques, and light detection and ranging (LIDAR)-based techniques.

In some cases, tracking vehicle 102 may track target vehicles using multiple independent sensor modalities. For example, tracking vehicle 102 may track target vehicles using images from a camera. Some convolutional neural network (CNN)-based tracking techniques work well in the pixel domain (e.g., based on pixel data of image frames). Such techniques allow for high fidelity in comprehending the scene. Such techniques may further allow for object detection, feature extraction, scene segmentation, and/or context detection, among other things. However, image-based techniques may be poor at three-dimensional (3D) localization of objects.

Further, tracking vehicle 102 may use RADAR-based tracking techniques. Such techniques may provide sparse low-fidelity data which may allow for good 3D localization. Further RADAR-based tracking techniques may allow for doppler-based velocity estimation. However, RADAR-based data may be ill-suited for object classification. For example, object classification techniques may struggle to classify objects based on RADAR-based data.

Tracking vehicle 102 may fuse image-based techniques and/or data with RADAR-based techniques and/or data for pose estimation and/or dynamics estimation. Fusing the techniques may allow tracking vehicle 102 to use the strengths of each technique. Fusing the techniques may include incorporating geometric sensor modeling for each sensor modality.

According to some techniques, tracking vehicle 102 may determine the location of lanes using perception techniques. Perception-based lane-location determination may suffer from longitudinal estimation errors. In the present disclosure, the term “longitude,” and like terms, may refer to a direction extending in front of a tracking vehicle. The term longitudinal errors may refer to errors in the longitudinal axis, such as errors in determining how distant a point or object (e.g., a lane boundary) in front of the tracking vehicle is from the tracking vehicle. Longitudinal errors may result from improperly relying on a flat-plane assumption, defects or limitations in cameras or sensors, and/or incorrect associations in bird's eye view (BEV) space.

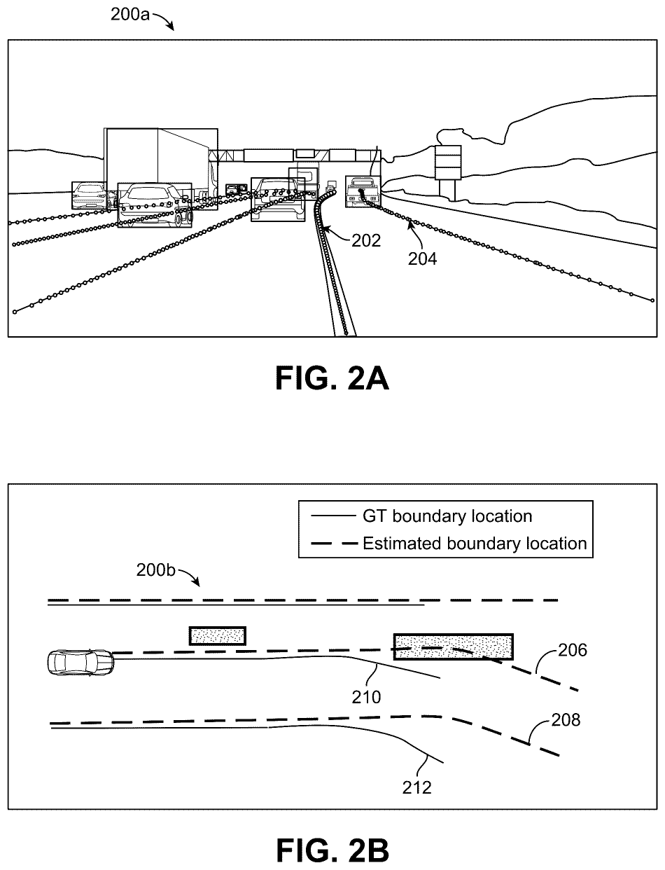

FIG. 2A and FIG. 2B illustrate such issues with perception-based lane-location techniques. As an example, FIG. 2A is a representation of an image 200a captured by a camera of a tracking vehicle (e.g., tracking vehicle 102 of FIG. 1). In image 200a, lane boundary 202 and lane boundary 204 shift to the right as the lanes get farther (in the longitudinal direction) from the tracking vehicle. FIG. 2B is a diagram illustrating a bird's eye view 200b of the environment. Bird's eye view 200b includes estimated lane boundary 206 and estimated lane boundary 208, which may be estimated using perception-based lane-location techniques. Bird's eye view 200b also includes actual lane boundary 210 and actual lane boundary 212, which may be actual lane boundaries. Estimated lane boundary 206 and estimated lane boundary 208 deviate from actual lane boundary 210 and actual lane boundary 212. The deviation is an example of longitudinal errors of a perception-based lane location technique.

According to some techniques, a tracking vehicle (e.g., tracking vehicle 102 of FIG. 1) may determine the location of lanes using a map (e.g., a point map, such as a high-definition (HD) map including lane boundaries). Maps can be inaccurate, out of date, or unavailable in some locations. Thus, lane associations based on perceptions of target vehicles and perceptions of lanes and/or based on maps can be inaccurate.

Systems, apparatuses, methods (also referred to as processes), and computer-readable media (collectively referred to herein as “systems and techniques”) are described herein for determining locations of target vehicles in relation to lanes based on images captured at a tracking vehicle. The systems and techniques described herein may be implemented at a tracking vehicle and may obtain an image of a target vehicle and a lane boundary. The systems and techniques may obtain a position of the target vehicle within the image and obtain one or more positions of the lane boundary within the image. The systems and techniques may determine a distance between the target vehicle and the lane boundary based on the position of the target vehicle within the image and the one or more positions of the lane boundary within the image.

An autonomous driving system may control an autonomous vehicle (which may track target vehicles and/or lane boundaries and may thus be referred to as a tracking vehicle) based on an internal map of the environment of the tracking vehicle. As noted previously, the term autonomous vehicle/system may also refer to semi-autonomous vehicle/systems in some aspects. In some cases, the autonomous driving system may obtain or determine the internal map based on a pre-determined map, for example, a point map (e.g., an HD map) of the environment. The autonomous driving system may determine and/or update the internal map based on perceptions of the environment. The internal map may include locations of lanes and locations of objects, including target vehicles. For example, the tracking vehicle may include cameras and may capture images of the environment of the tracking vehicle regularly (e.g., at a rate of a number of frames per second). The autonomous driving system may obtain the images and may determine and/or update the internal map based on the images. For example, the autonomous driving system may determine and/or update the locations of lane boundaries and/or locations of the target vehicles in the internal map.

The systems and techniques may determine the locations of target vehicles in relation to the lane boundaries based on the images. For example, the systems and techniques may determine a lateral offset between a target vehicle and a lane boundary. The systems and techniques may adjust the locations of the target vehicles in the internal map based on the determined lateral offset. For example, the systems and techniques may determine internal map including the locations of the lane boundaries and the location of a target vehicle (e.g., based on a pre-determined map and/or based on perception-based techniques). Then, based on one or more images, the systems and techniques may determine a lateral offset between a target vehicle and a lane boundary. Next, the systems and techniques may adjust the location of the target vehicle in the internal map to reflect the determined lateral offset between the target vehicle relative to the lane boundaries.

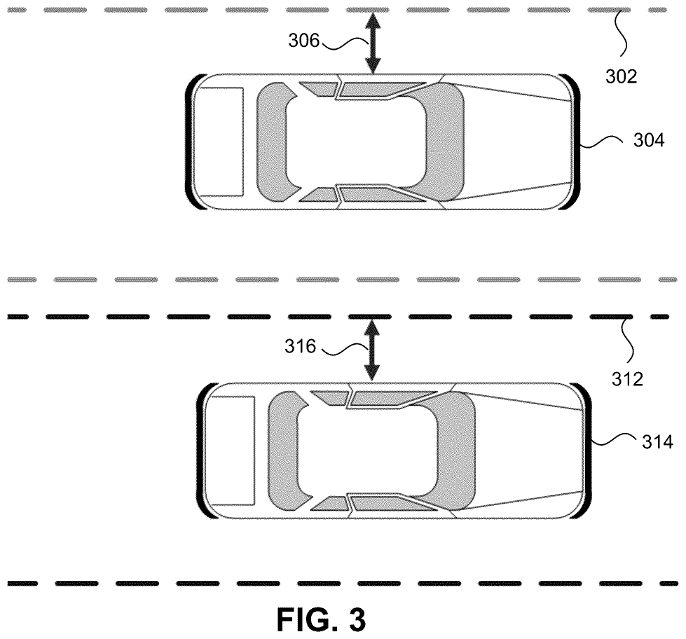

FIG. 3 is a diagram illustrating an example of adjusting a location of a target vehicle in an internal map based on a relationship between a lane boundary and the target vehicle in an image, according to various aspects of the present disclosure. In particular, FIG. 3 illustrates image-based lane boundary 312 which represents the location of a lane boundary if the location of the lane boundary were determined based on an image (and/or other perception techniques). Further, FIG. 3 illustrates internal-map lane boundary 302 which represents the lane boundary as stored in the internal map. Internal-map lane boundary 302 may be different from image-based lane boundary 312 based on internal-map lane boundary 302 being based on a point map (e.g., an HD map), based on image-based lane boundary 312 exhibiting longitudinal errors, and/or based on other factors.

Further, FIG. 3 illustrates image-based target-vehicle 314 which represents the location of a target vehicle if the location were determined based on the image (and/or other perception techniques). FIG. 3 also illustrates internal-map target-vehicle 304 which represents the location of the target vehicle as stored in the internal map. Internal-map target-vehicle 304 may be different from image-based target-vehicle 314 based on internal-map target-vehicle 304 being based on a detection and ranging technique (e.g., LIDAR or RADAR), based on image-based target-vehicle 314 exhibiting longitudinal errors, and/or based on other factors.

The systems and techniques may determine a location of image-based target-vehicle 314 relative to image-based lane boundary 312. Lateral offset 316 is illustrated as an example of a way to describe the location of image-based target-vehicle 314 relative to image-based lane boundary 312. In other cases, the location of image-based target-vehicle 314 relative to image-based lane boundary 312 may be described based on a center point of image-based target-vehicle 314, and/or a center of the lane defined by image-based lane boundary 312. In any case, the systems and techniques may determine lateral offset 316 based on one or more images.

In some cases, the systems and techniques may determine or adjust a location of internal-map target-vehicle 304 based on lateral offset 316. In other cases, the systems and techniques may determine the location of internal-map target-vehicle 304 based on lateral offset 316. In particular, the systems and techniques may determine or adjust the location of internal-map target-vehicle 304 in the internal map to be lateral offset 306 (which may be the same as lateral offset 316) from internal-map lane boundary 302.

Regardless of whether internal-map lane boundary 302 or image-based lane boundary 312 more accurately reflects the location of the lane boundary in reality, by basing the location of internal-map target-vehicle 304 on lateral offset 306, the systems and techniques ensure that the location of internal-map target-vehicle 304 relative to internal-map lane boundary 302 is accurate.

Basing the locations of target vehicles in an internal map on lateral offsets may cause the internal map to be consistent. For example, if locations of lane boundaries of an internal map are determined based, at least in part, on a pre-determined map (which may be inaccurate or out of date) and if the locations of target vehicles in the internal map are determined based on perceptions, the locations of the target vehicles with relation to the lane boundaries may not be accurate. For instance, the locations of the target vehicles with relation to the tracking vehicle may be accurate but the position of the lane boundaries with relation to the tracking vehicle may be inaccurate. Thus, the locations of the target vehicles with relation to the lane boundaries may be inaccurate. As another example, if locations of lane boundaries of an internal map are determined based on perceptions (which may exhibit longitudinal errors) and locations of target vehicles in the internal map are based, at least in part, a detection and ranging technique (e.g., LIDAR or RADAR), the locations of the target vehicles with relation to the lane boundaries may not be accurate. For instance, the locations of the target vehicles with relation to the tracking vehicle may be accurate but the position of the lane boundaries with relation to the tracking vehicle may be inaccurate. Thus, the locations of the target vehicles with relation to the lane boundaries may be inaccurate.

By adjusting the locations of target vehicles in the internal map based on lateral offsets determined based on one or more images, the systems and techniques may cause the locations of the target vehicles relative to the lane boundaries in the internal map to be consistent. Thus, even if the locations of the lane boundaries are inaccurate (e.g., based on longitudinal errors) the locations of the target vehicles with relation to the lane boundaries will be consistent. For controlling a tracking vehicle (e.g., planning maneuvers), it may be important to an autonomous driving system to have consistent information regarding the location of target vehicles with relation to lane boundaries. For example, in order to determine which lane to drive in, it may be important to have consistent information regarding which lanes target vehicles are in (or are moving into) regardless of whether the locations of distant lane boundaries are accurate or not.

The systems and techniques can satisfy various requirements or goals, including determining locations of target vehicles in relation to lanes for drive-by-perception use cases, being robust to errors in online map generation, being robust to errors in high-definition (HD)-maps, handling complicated lane geometries, performing splits and/or merges, any combination thereof, and/or others.

One or more inputs can be used by the systems and techniques in performing operations according to aspects described herein. For example, inputs can include two-dimensional (2D) pixel level camera inputs, bounding boxes for objects with classification, 2D lane markers with semantic assignment, among others. Outputs of the systems and techniques can include lateral offsets or other indications of locations target vehicles in relation to lane boundaries. The lateral offsets may be represented as signed scalar quantities. In some cases, the systems and techniques may determine and/or provide as outputs indications of locations target vehicles in relation to each lane boundary.

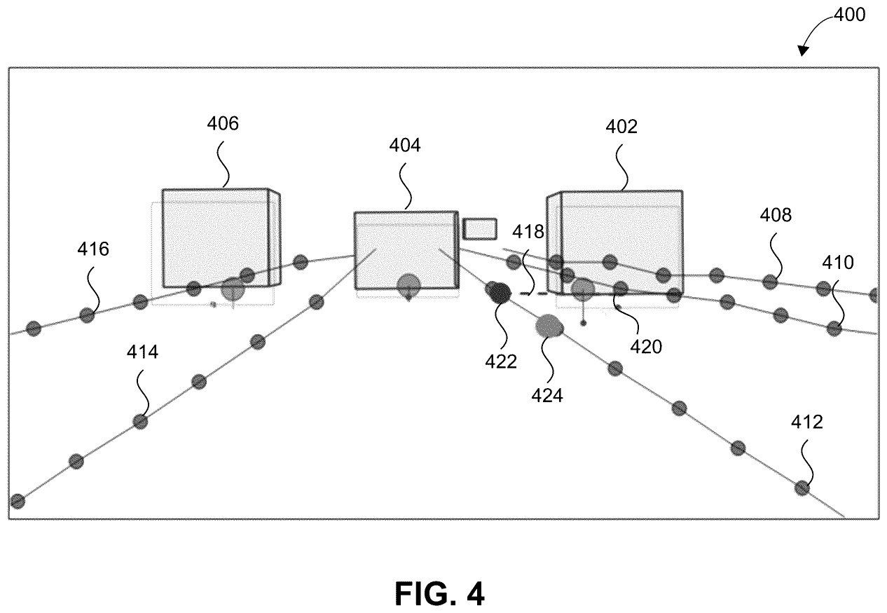

FIG. 4 is a diagram illustrating data points arranged in an image plane 400 that may be used to determine a location of a target vehicle relative to a lane boundary, according to various aspects of the present disclosure. In some cases, the systems and techniques may obtain one or more images and determine data points illustrated in FIG. 4 based on the one or more images. In other cases, the data points illustrated in FIG. 4 may be provided to the systems and techniques.

For example, the bounding boxes (e.g., bounding box 402, bounding box 404, and/or bounding box 406) may be determined using an object-detection and/or object-tracking technique based on respective target vehicles in the one or more images. Each of bounding box 402, bounding box 404, and bounding box 406 may represent a position of the respective target vehicles in one image (e.g., a most-recently obtained image) of the one or more images. Bounding box 402, bounding box 404, and bounding box 406 may be projections of three-dimensional bounding boxes projected onto image plane 400.

Additionally, the lane boundaries (e.g., lane boundary 408, lane boundary 410, lane boundary 412, lane boundary 414, and/or lane boundary 416) may be determined using an object-detection and/or object-tracking technique based on respective lane markers in the one or more images. Each of lane boundary 408, lane boundary 410, lane boundary 412, lane boundary 414, and lane boundary 416 may be, or may include, a respective number of discrete points (e.g., illustrated as circles, defining positions of the respective lane boundary. It may be assumed that the lane boundary extends linearly between the discrete points.

The systems and techniques may determine locations of target vehicles (e.g., the target vehicles represented by bounding box 402, bounding box 404, and/or bounding box 406) relative to lane boundary 408, lane boundary 410, lane boundary 412, lane boundary 414, and/or lane boundary 416. In some cases, the systems and techniques may determine a distance (e.g., a lateral distance) between each of bounding box 402, bounding box 404, bounding box 406, and each of lane boundary 408, lane boundary 410, lane boundary 412, lane boundary 414, and lane boundary 416. The process for determining axis-aligned offset 418 is provided as an example. Axis-aligned offset 418 itself is provided as an example of a metric for describing a location of a target vehicle on which bounding box 402 is based relative to lane boundary 412. In particular, axis-aligned offset 418 may be a distance between a center point of a bottom plane of bounding box 402 and lane boundary 412. Further, axis-aligned offset 418 may be determined between bounding box 402 and a point that is in between the discrete points of lane boundary 412.

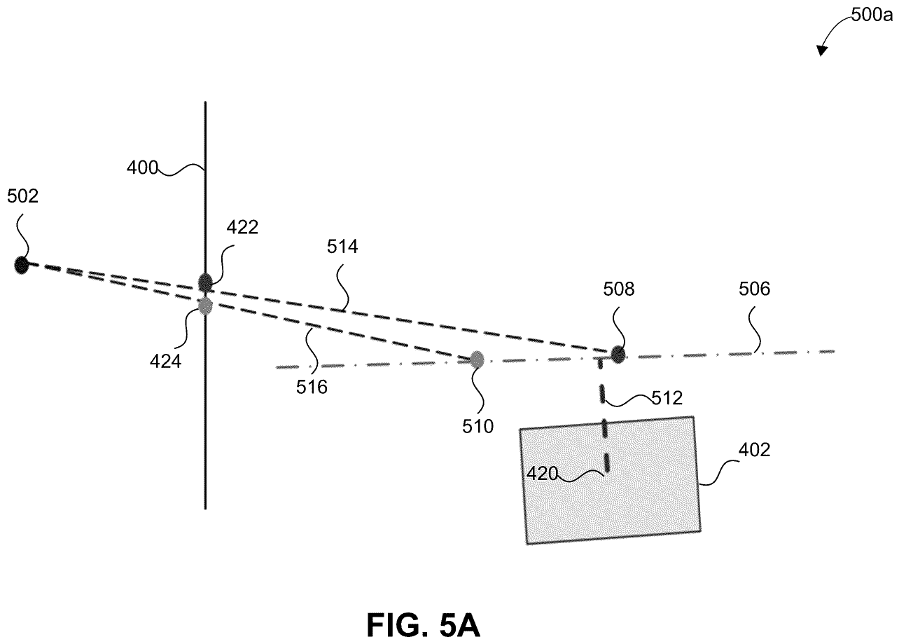

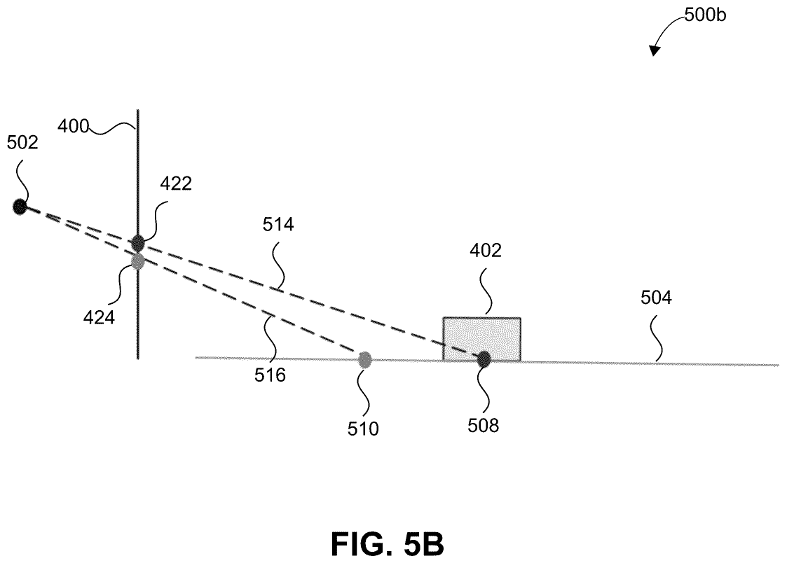

FIG. 5A is a diagram illustrating a top view 500a of bounding box 402 and a projected lane boundary 506 to provide context for a description of an example process for determining a lateral offset 512 between a vehicle and a lane boundary. FIG. 5B is a diagram illustrating a side view 500b of the bounding box 402 and a ground plane 504 to provide context for the description of the example process for determining a lateral offset 512 between a vehicle and a lane boundary.

According to the example process, a center point 420 of bounding box 402 may be determined. Center point 420 may be a geometric center of a bottom plane of bounding box 402. Further, an axis-aligned offset 418 may be determined between center point 420 and axis-aligned point 422. Axis-aligned offset 418 may be determined be drawing a line (e.g., a line that is parallel with a bottom of image plane 400) in image plane 400 from center point 420 to lane boundary 412. The point at which the line intersects with lane boundary 412 in image plane 400 may define axis-aligned point 422. A prior position 424 of lane boundary 412 in image plane 400 may be identified.

Having defined axis-aligned point 422, a ray 514 may be projected from a camera center 502 through axis-aligned point 422 into a simulated three-dimensional space. Additionally, having defined prior position 424, a ray 516 may be projected from camera center 502 through prior position 424 into the simulated three-dimensional space. The simulated three-dimensional space may include the ground plane 504. A projected axis-aligned point 508 may be defined based on where ray 514 intersects with ground plane 504. A projected prior point 510 may be defined based on where ray 516 intersects with ground plane 504. Projected lane boundary 506 may be projected between projected axis-aligned point 508 and projected prior point 510. Projected lane boundary 506 may represent a portion of lane boundary 412 in the simulated three-dimensional space (e.g., projected lane boundary 506 may represent the portion of lane boundary 412 that is relevant to determining lateral offset 512).

Having defined projected lane boundary 506, a line that is perpendicular to projected lane boundary 506 may be projected between projected lane boundary 506 and center point 420. The length of the line may be lateral offset 512. As such, lateral offset 512 may be defined as a distance between lane boundary 412 and center point 420.

In some aspects, the systems and techniques may track and/or update lateral offsets using a number of images. For example, the systems and techniques may determine a lateral offset once for each image captured by the tracking vehicle and update a final lateral offset based on the lateral offsets determined for each of the images.

As an example, the systems and techniques may maintain lateral offsets using a Kalman filter. For example, a lateral offset determined based on one image may be used as a measurement and represented by zₖ. A state, represented by xₖ, may represent a lateral offset determined based on multiple measurements. A measurement model may be represented by:

zₖ=xₖ+nₖ
where nₖ˜N(0,σₙ²), and
where σₙ is modeled in terms of assumed pixel noise.

The states transition model may be represented by:

xₖ₊₁=xₖ+vₖΔₜ,
where v k is representative of velocity and is modeled as N(0,σᵥ²)),
where Δₜ is the time that elapses between capturing images, and
where σᵥ is a selected value (e.g., 5 meters per second).

In some aspects, the systems and techniques may additionally track and/or update lane boundaries using a number of images. For example, the systems and techniques may determine positions of the lane boundaries once for each image captures by the tracking vehicle and update final lane boundaries based on the lane boundaries determined for each of the images. As an example, the systems and techniques may maintain lane boundaries using a Kalman filter.

Additionally, the systems and techniques may determine associations between lane boundaries between images. For example, the systems and techniques may determine an associate between lane boundaries determined in a most-recently-captured image and lane boundaries that are based on previously-captured images (e.g., that have been tracked and/or updated across multiple images). By associating lanes between images, the systems and techniques may be able to accurately determine lane boundaries even when a tracking vehicle changes lanes, when lanes split, when lanes merge. A change to any lane may affect all lane boundaries because all lane boundaries may be defined with relation to a lane of the tracking vehicle. For example, if the tracking vehicle changes lanes, all of the lane boundaries may need to be adjusted to reflect a new relationship to the new lane of the tracking vehicle. As another example, if the lane of the tracking vehicle merges with another lane, lanes adjacent to the other lane may need to be updated to reflect their new relationship to the lane of the tracking vehicle.

As an example of determining associations between lane boundaries, a lane associator may receive as inputs lane boundaries (Lₚₐₛₜ) based on a number of prior images and lane boundaries (L_{curr}) based on a most-recently-received image. Lₚₐₛₜ may be maintained based on a Kalman filter. The lane associator may determine association costs between all pairs (lₚ, l_{c}) such that lₚ∈Lₚₐₛₜ and l_{c}∈L_{curr}. Where lₚ and l_{c} represent two lane boundaries and the cost of association can be determined by

$${cost}_{assoc} ∝ \frac{{d}_{pc}}{{w}_{l}}$$

where d_{pc} is a pixel distance between lₚ and l_{c} at y=0.75*h,
where h is the height of the image frame,
where

$${w}_{l} = \frac{w}{n} ,$$

where w is width of the image frame, and
where n is the max number of observable lanes.

Further, the lane associator may perform matching on an association cost matrix using a linear sum assignment problem. The lane associator may output vector matches including existing Kalman filters that are re-assigned and/or updated based on lateral offsets. Further, the lane associator may output a vector of unassociated new lane boundaries including new Kalman filters initialized for unassociated lane boundaries. Further, the lane associator may output a vector of unassociated past lane boundaries. The Kalman filters of the unassociated past lane boundaries may be promoted to the new image.

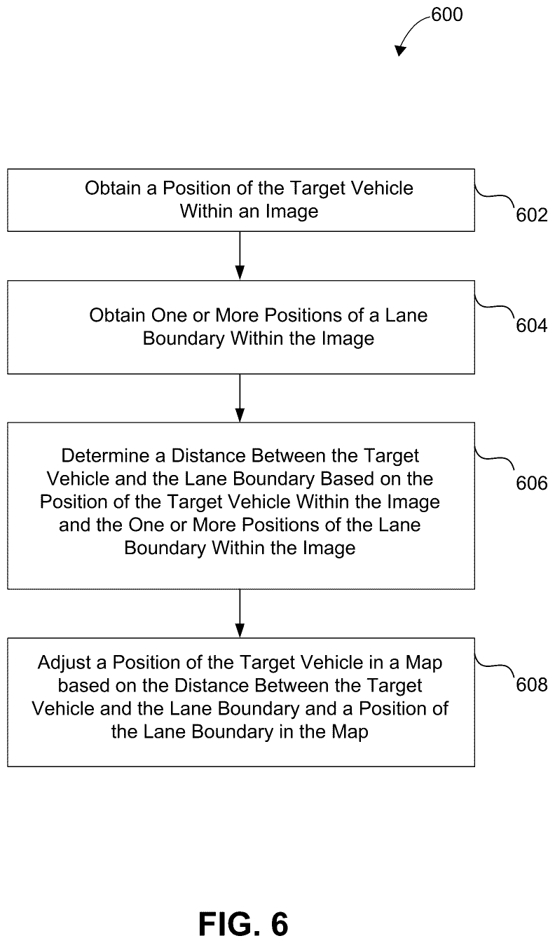

FIG. 6 is a flow diagram illustrating a process 600 for determining a location of a target vehicle in relation to a lane boundary, in accordance with aspects of the present disclosure. One or more operations of process 600 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 600. The one or more operations of process 600 may be implemented as software components that are executed and run on one or more processors.

At block 602, a computing device (or one or more components thereof) may obtain a position of a target vehicle within an image. For example, a computing device (or one or more components thereof) of tracking vehicle 102 may obtain bounding box 402. The position of the target vehicle within image plane 400 may be determined based on bounding box 402.

In some aspects, the computing device (or one or more components thereof) may obtain the image including and determine the position of the target vehicle within the image. For example, the computing device (or one or more components thereof) may obtain an image (e.g., from a camera of tracking vehicle 102). The image may include the target vehicle. The computing device (or one or more components thereof) may obtain a position of a target vehicle (e.g., a point of a bounding box 402) within image plane 400 based on the bounding box. For example, in some cases, the position may be center point 420 of bounding box 402.

In some aspects, the computing device (or one or more components thereof) may determine the position of the target vehicle within the image based on a plurality of images. For example, the computing device (or one or more components thereof) may obtain multiple images (e.g., from a camera of tracking vehicle 102). The multiple images may include the target vehicle. The computing device (or one or more components thereof) may obtain a position of a target vehicle (e.g., a point of a bounding box 402) within image plane 400 based on the multiple images.

In some aspects, the computing device (or one or more components thereof) may determine a bounding box associated with the target vehicle based on a plurality of images and determine the position of the target vehicle based on the bounding box. For example, the computing device (or one or more components thereof) may obtain multiple images (e.g., from a camera of tracking vehicle 102). The multiple images may include the target vehicle. The computing device (or one or more components thereof) may determine bounding box 402 based on the multiple images. For example, the computing device (or one or more components thereof) may use an object-detection and/or object tracking-technique to determine bounding box 402. The determine the position of the target vehicle based on bounding box 402.

At block 604, the computing device (or one or more components thereof) may obtain one or more positions of a lane boundary within the image. For example, the computing device (or one or more components thereof) may obtain one or more positions of lane boundary 412 within image plane 400.

In some aspects, the computing device (or one or more components thereof) may determine the one or more positions of the lane boundary within the image based on a plurality of images. For example, the computing device (or one or more components thereof) may obtain multiple images (e.g., a series of images captured by a camera of tracking vehicle 102). The multiple images may include lane boundary 412. The computing device (or one or more components thereof) may determine the one or more positions of lane boundary 412 based on the image obtained at block 602 and based on the multiple images. In some aspects, the computing device (or one or more components thereof) may track, using a Kalman filter, the one or more positions of the lane boundary within the image based on a plurality of images. For example, the computing device (or one or more components thereof) may use a Kalman filter to track the positions of lane boundary 412 in the image obtained at block 602 and the multiple images.

In some aspects, the computing device (or one or more components thereof) may update tracked positions of the one or more positions of the lane boundary based on the image. For example, the computing device (or one or more components thereof) may track positions of lane boundary 412. Further, the computing device (or one or more components thereof) may update the tracked positions of lane boundary 412 based on the image obtained at block 602.

In some aspects, the computing device (or one or more components thereof) may obtain one or more prior positions of one or more lane boundaries determined based on one or more prior images and associate the one or more positions of the lane boundary with one or more prior positions of a lane boundary of the one or more lane boundaries. For example, the computing device (or one or more components thereof) may obtain multiple images (e.g., a series of images captured by a camera of tracking vehicle 102). The multiple images may include lane boundary 412. The computing device (or one or more components thereof) may obtain prior positions of the lane boundary 412 based on the images. The computing device (or one or more components thereof) may associate the one or more positions of the lane boundary 412 (obtained at block 604) with the prior positions of the lane boundary 412. In some aspects, the computing device (or one or more components thereof) may determine a cost of associating the one or more positions of the lane boundary with the one or more prior positions of the lane boundary of the one or more lane boundaries, wherein the cost is proportional to a pixel distance in the image between the one or more positions of the lane boundary and the one or more prior positions of the lane boundary of the one or more lane boundaries divided by a width of the image. For example, the computing device (or one or more components thereof) may determine a cost of associating the one or more positions of lane boundary 412 (obtained at block 604) with the prior positions of the lane boundary 412 (determined based on the images). The cost may be determined to be proportional to a pixel distance in the image (obtained at block 602) between the one or more positions of lane boundary 412 and the one or more prior positions of lane boundary 412 (determined based on the images) divided by a width of the image.

At block 606, the computing device (or one or more components thereof) may determine a distance between the target vehicle and the lane boundary based on the position of the target vehicle within the image and the one or more positions of the lane boundary within the image. For example, the computing device (or one or more components thereof) may determine axis-aligned offset 418 between the point of bounding box 402 and lane boundary 412.

In some aspects, to determine the distance between the target vehicle and the lane boundary, the computing device (or one or more components thereof) may determine a distance between a center point of a bottom plane of a bounding box of the target vehicle and the lane boundary. For example, the computing device (or one or more components thereof) may determine a distance between center point 420 and lane boundary 412.

In some aspects, to determine the distance between the target vehicle and the lane boundary, the computing device (or one or more components thereof) may determine a distance between the target vehicle and a point of the lane boundary between the one or more positions of the lane boundary. For example, the computing device (or one or more components thereof) may determine a distance between bounding box 402 and axis-aligned point 422 to determine axis-aligned offset 418.

In some aspects, the computing device (or one or more components thereof) may to track the distance between the target vehicle and the lane boundary over a plurality of images. For example, having determined axis-aligned offset 418, at block 606 based on the image obtained at block 602 and the positions obtained at block 604, the computing device (or one or more components thereof) may obtain additional images and additional positions of lane boundary 412. The computing device (or one or more components thereof) may determine additional distances based on the additional images and the additional positions. The computing device (or one or more components thereof) may track the distance obtained at block 606 based on the additional distances. In some aspects, the computing device (or one or more components thereof) may to track, using a Kalman filter, the distance between the target vehicle and the lane boundary over a plurality of images. For example, the computing device (or one or more components thereof) may use a Kalman filter to track the track the distance obtained at block 606 based on the additional distances.

At block 608, the computing device (or one or more components thereof) may adjust a position of the target vehicle in a map based on the distance between the target vehicle and the lane boundary and a position of the lane boundary in the map. For example, the computing device (or one or more components thereof) may adjust a location of internal-map target-vehicle 304 based on lateral offset 316.

In some aspects, the computing device (or one or more components thereof) may plan a path of a tracking vehicle based on the map and/or control the tracking vehicle based on the map. For example, tracking vehicle 102 may plan a path of tracking vehicle 102 and/or may control tracking vehicle 102 based on the map. In some aspects, tracking vehicle 102 may determine lane lateral offsets for multiple vehicles (e.g., target vehicle 104, target vehicle 106, and target vehicle 108). Tracking vehicle 102 may plan its path and/or control its movement (e.g., acceleration, braking, and/or steering) based on the lateral offsets.

In some aspects, the computing device (or one or more components thereof) may determine a lane association of the target vehicle based on the distance between the target vehicle and the lane boundary. For example, the computing device (or one or more components thereof) may determine to associate a lane (e.g., a lane defined by lane boundary 412 and lane boundary 410) with bounding box 402 based on axis-aligned offset 418. In some aspects, the computing device (or one or more components thereof) may plan a path of a tracking vehicle based on the map and/or control the tracking vehicle based on the lane association. For example, tracking vehicle 102 may plan a path of tracking vehicle 102 and/or may control tracking vehicle 102 based on the lane associated with the target vehicle. In some aspects, tracking vehicle 102 may determine lane associations for multiple target vehicles, (e.g., target vehicle 104, target vehicle 106, and target vehicle 108). Tracking vehicle 102 may plan its path and/or control its movement (e.g., acceleration, braking, and/or steering) based on the lanes associated with the target vehicles.

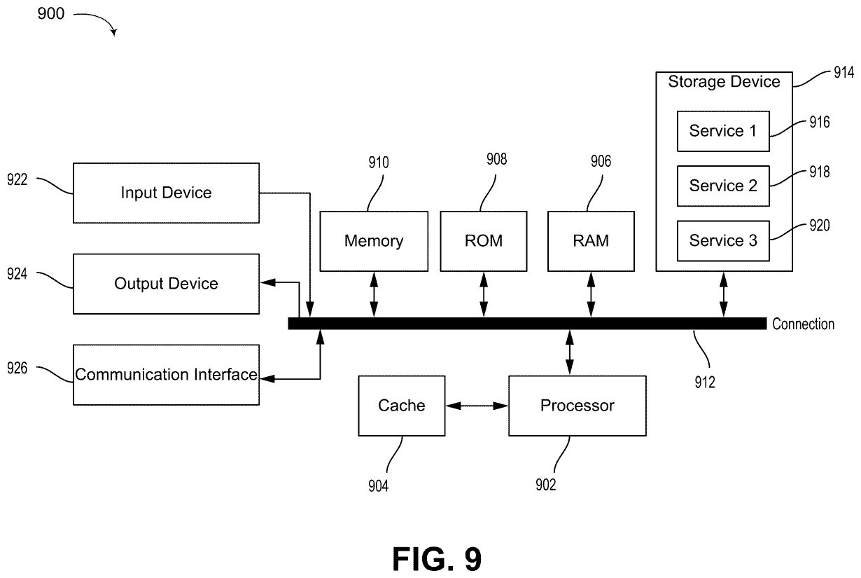

In some examples, as noted previously, the methods described herein (e.g., process 600 of FIG. 6, and/or other methods described herein) can be performed, in whole or in part, by a computing device or apparatus. In one example, one or more of the methods can be performed by a computing system of tracking vehicle 102, or by another system or device. In another example, one or more of the methods (e.g., process 600 of FIG. 6, and/or other methods described herein) can be performed, in whole or in part, by the computing-device architecture 900 shown in FIG. 9. For instance, a computing device with the computing-device architecture 900 shown in FIG. 9 can include, or be included in, the components of the computing system of tracking vehicle 102 and can implement the operations of process 600, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 600 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

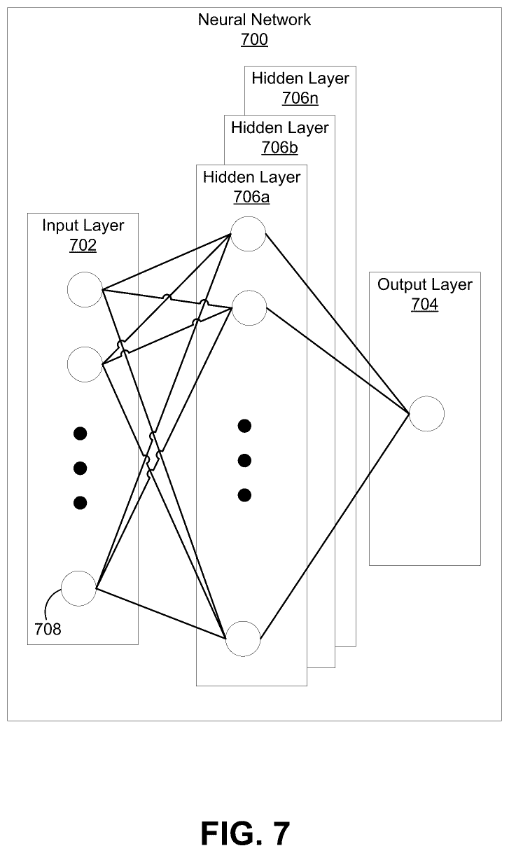

FIG. 7 is a diagram illustrating an example of a neural network 700 (e.g., a deep-learning neural network) that can be used to implement the machine-learning based object detection, object tracking, vehicle tracking, vehicle detection, lane detection, lane tracking, feature segmentation, implicit-neural-representation generation, rendering, and/or classification described above.

An input layer 702 includes input data. In one illustrative example, input layer 702 can include data representing images captured by the tracking vehicle. Neural network 700 includes multiple hidden layers hidden layers 706a, 706b, through 706n. The hidden layers 706a, 706b, through hidden layer 706n include “n” number of hidden layers, where “n” is an integer greater than or equal to one. The number of hidden layers can be made to include as many layers as needed for the given application. Neural network 700 further includes an output layer 704 that provides an output resulting from the processing performed by the hidden layers 706a, 706b, through 706n. In one illustrative example, output layer 704 can provide positions of target vehicles (e.g., bounding boxes) and/or positions of lane boundaries.

Neural network 700 can be, or can include, a multi-layer neural network of interconnected nodes. Each node can represent a piece of information. Information associated with the nodes is shared among the different layers and each layer retains information as information is processed. In some cases, neural network 700 can include a feed-forward network, in which case there are no feedback connections where outputs of the network are fed back into itself. In some cases, neural network 700 can include a recurrent neural network, which can have loops that allow information to be carried across nodes while reading in input.

Information can be exchanged between nodes through node-to-node interconnections between the various layers. Nodes of input layer 702 can activate a set of nodes in the first hidden layer 706a. For example, as shown, each of the input nodes of input layer 702 is connected to each of the nodes of the first hidden layer 706a. The nodes of first hidden layer 706a can transform the information of each input node by applying activation functions to the input node information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 706n can activate one or more nodes of the output layer 704, at which an output is provided. In some cases, while nodes (e.g., node 708) in neural network 700 are shown as having multiple output lines, a node has a single output and all lines shown as being output from a node represent the same output value.

In some cases, each node or interconnection between nodes can have a weight that is a set of parameters derived from the training of neural network 700. Once neural network 700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 700 to be adaptive to inputs and able to learn as more and more data is processed.

Neural network 700 may be pre-trained to process the features from the data in the input layer 702 using the different hidden layers 706a, 706b, through 706n in order to provide the output through the output layer 704. In an example in which neural network 700 is used to identify features in images, neural network 700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 700 is trained well enough so that the weights of the layers are accurately tuned.

For the example of identifying objects in images, the forward pass can include passing a training image through neural network 700. The weights are initially randomized before neural network 700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 700 can include any other deep network other than a CNN, such as an autoencoder, a deep belief nets (DBNs), a Recurrent Neural Networks (RNNs), among others.

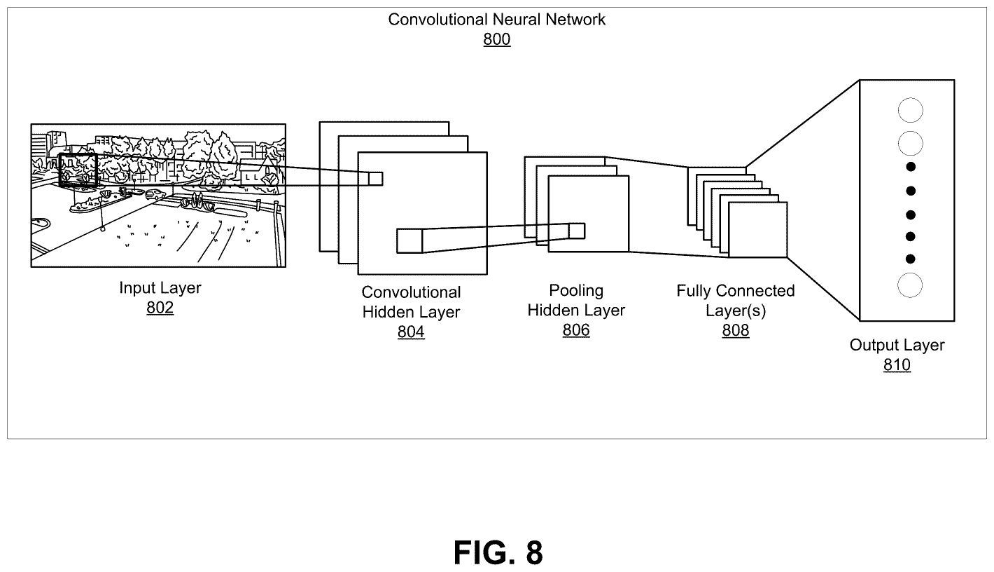

FIG. 8 is a diagram illustrating an example of a convolutional neural network (CNN) 800. The input layer 802 of the CNN 800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 804, an optional non-linear activation layer, a pooling hidden layer 806, and fully connected layer 808 (which fully connected layer 808 can be hidden) to get an output at the output layer 810. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 can be the convolutional hidden layer 804. The convolutional hidden layer 804 can analyze image data of the input layer 802. Each node of the convolutional hidden layer 804 is connected to a region of nodes (pixels) of the input image called a receptive field. The convolutional hidden layer 804 can be considered as one or more filters (each filter corresponding to a different activation or feature map), with each convolutional iteration of a filter being a node or neuron of the convolutional hidden layer 804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 804. Each connection between a node and a receptive field for that node learns a weight and, in some cases, an overall bias such that each node learns to analyze its particular local receptive field in the input image. Each node of the convolutional hidden layer 804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 804 is due to each node of the convolutional layer being applied to its corresponding receptive field. For example, a filter of the convolutional hidden layer 804 can begin in the top-left corner of the input image array and can convolve around the input image. As noted above, each convolutional iteration of the filter can be considered a node or neuron of the convolutional hidden layer 804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 804. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 804.

The mapping from the input layer to the convolutional hidden layer 804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 804 can include several activation maps in order to identify multiple features in an image. The example shown in FIG. 8 includes three activation maps. Using three activation maps, the convolutional hidden layer 804 can detect three different kinds of features, with each feature being detectable across the entire image.

In some examples, a non-linear hidden layer can be applied after the convolutional hidden layer 804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 804.

The pooling hidden layer 806 can be applied after the convolutional hidden layer 804 (and after the non-linear hidden layer when used). The pooling hidden layer 806 is used to simplify the information in the output from the convolutional hidden layer 804. For example, the pooling hidden layer 806 can take each activation map output from the convolutional hidden layer 804 and generates a condensed activation map (or feature map) using a pooling function. Max-pooling is one example of a function performed by a pooling hidden layer. Other forms of pooling functions be used by the pooling hidden layer 806, such as average pooling, L2-norm pooling, or other suitable pooling functions. A pooling function (e.g., a max-pooling filter, an L2-norm filter, or other suitable pooling filter) is applied to each activation map included in the convolutional hidden layer 804. In the example shown in FIG. 8, three pooling filters are used for the three activation maps in the convolutional hidden layer 804.

In some examples, max-pooling can be used by applying a max-pooling filter (e.g., having a size of 2×2) with a stride (e.g., equal to a dimension of the filter, such as a stride of 2) to an activation map output from the convolutional hidden layer 804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 804 having a dimension of 24×24 nodes, the output from the pooling hidden layer 806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 806 to every one of the output nodes in the output layer 810. Using the example above, the input layer includes 28×28 nodes encoding the pixel intensities of the input image, the convolutional hidden layer 804 includes 3×24×24 hidden feature nodes based on application of a 5×5 local receptive field (for the filters) to three activation maps, and the pooling hidden layer 806 includes a layer of 3×12×12 hidden feature nodes based on application of max-pooling filter to 2×2 regions across each of the three feature maps. Extending this example, the output layer 810 can include ten output nodes. In such an example, every node of the 3×12×12 pooling hidden layer 806 is connected to every node of the output layer 810.

The fully connected layer 808 can obtain the output of the previous pooling hidden layer 806 (which should represent the activation maps of high-level features) and determines the features that most correlate to a particular class. For example, the fully connected layer 808 can determine the high-level features that most strongly correlate to a particular class and can include weights (nodes) for the high-level features. A product can be computed between the weights of the fully connected layer 808 and the pooling hidden layer 806 to obtain probabilities for the different classes. For example, if the CNN 800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 810 can include an M-dimensional vector (in the prior example, M=10). M indicates the number of classes that the CNN 800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9 is a diagram illustrating an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of a computing system of tracking vehicle 102 of FIG. 1.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for determining at least one location of at least one target vehicle relative to a lane, the apparatus comprising: at least one memory; and at least one processor coupled to the at least one memory and configured to: obtain a position of a target vehicle within an image; obtain one or more positions of a lane boundary within the image; determine a distance between the target vehicle and the lane boundary based on the position of the target vehicle within the image and the one or more positions of the lane boundary within the image; and adjust a position of the target vehicle in a map based on the distance between the target vehicle and the lane boundary and a position of the lane boundary in the map.

Aspect 2. The apparatus of aspect 1, wherein the at least one processor is further configured to perform an operation, wherein the operation is at least one of: planning a path of a tracking vehicle based on the map; or controlling the tracking vehicle based on the map.

Aspect 3. The apparatus of any one of aspects 1 or 2, wherein the at least one processor is further configured to determine a lane association of the target vehicle based on the distance between the target vehicle and the lane boundary.

Aspect 4. The apparatus of any one of aspects 1 to 3, wherein the at least one processor is further configured to control a tracking vehicle based, at least in part, on the lane association of the target vehicle.

Aspect 5. The apparatus of any one of aspects 1 to 4, wherein, to determine the distance between the target vehicle and the lane boundary, the at least one processor is further configured to determine a distance between a center point of a bottom plane of a bounding box of the target vehicle and the lane boundary.

Aspect 6. The apparatus of any one of aspects 1 to 5, wherein the at least one processor is further configured to: obtain one or more prior positions of one or more lane boundaries determined based on one or more prior images; and associate the one or more positions of the lane boundary with one or more prior positions of a lane boundary of the one or more lane boundaries.

Aspect 7. The apparatus of aspect 6, wherein the at least one processor is further configured to determine a cost of associating the one or more positions of the lane boundary with the one or more prior positions of the lane boundary of the one or more lane boundaries, wherein the cost is proportional to a pixel distance in the image between the one or more positions of the lane boundary and the one or more prior positions of the lane boundary of the one or more lane boundaries divided by a width of the image.

Aspect 8. The apparatus of any one of aspects 1 to 7, wherein the at least one processor is further configured to determine the one or more positions of the lane boundary within the image based on a plurality of images.

Aspect 9. The apparatus of any one of aspects 1 to 8, wherein the at least one processor is further configured to track, using a Kalman filter, the one or more positions of the lane boundary within the image based on a plurality of images.

Aspect 10. The apparatus of any one of aspects 1 to 9, wherein the at least one processor is further configured to update tracked positions of the one or more positions of the lane boundary based on the image.

Aspect 11. The apparatus of any one of aspects 1 to 10, wherein, to determine the distance between the target vehicle and the lane boundary, the at least one processor is further configured to determine a distance between the target vehicle and a point of the lane boundary between the one or more positions of the lane boundary.

Aspect 12. The apparatus of any one of aspects 1 to 11, wherein the at least one processor is further configured to track the distance between the target vehicle and the lane boundary over a plurality of images.

Aspect 13. The apparatus of any one of aspects 1 to 12, wherein the at least one processor is further configured to track, using a Kalman filter, the distance between the target vehicle and the lane boundary over a plurality of images.

Aspect 14. The apparatus of any one of aspects 1 to 13, wherein the at least one processor is further configured to obtain the image and determine the position of the target vehicle within the image.

Aspect 15. The apparatus of any one of aspects 1 to 14, wherein the at least one processor is further configured to determine the position of the target vehicle within the image based on a plurality of images.

Aspect 16. The apparatus of any one of aspects 1 to 15, wherein the at least one processor is further configured to determine a bounding box associated with the target vehicle based on a plurality of images and determine the position of the target vehicle based on the bounding box.

Aspect 17. A method for determining at least one location of at least one target vehicle relative to a lane, the method comprising: obtaining a position of a target vehicle within an image; obtaining one or more positions of a lane boundary within the image; determining a distance between the target vehicle and the lane boundary based on the position of the target vehicle within the image and the one or more positions of the lane boundary within the image; and adjusting a position of the target vehicle in a map based on the distance between the target vehicle and the lane boundary and a position of the lane boundary in the map.

Aspect 18. The method of aspect 17, further comprising an operation, wherein the operation is at least one of: planning a path of a tracking vehicle based on the map; or controlling the tracking vehicle based on the map.

Aspect 19. The method of any one of aspects 17 or 18, further comprising determining a lane association of the target vehicle based on the distance between the target vehicle and the lane boundary.

Aspect 20. The method of any one of aspects 17 to 19, further comprising controlling a tracking vehicle based, at least in part, on the lane association of the target vehicle.

Aspect 21. The method of any one of aspects 17 to 20, wherein determining the distance between the target vehicle and the lane boundary comprises determining a distance between a center point of a bottom plane of a bounding box of the target vehicle and the lane boundary.

Aspect 22. The method of any one of aspects 17 to 21, further comprising: obtaining one or more prior positions of one or more lane boundaries determined based on one or more prior images; and associating the one or more positions of the lane boundary with one or more prior positions of a lane boundary of the one or more lane boundaries.

Aspect 23. The method of aspect 22, further comprising determining a cost of associating the one or more positions of the lane boundary with the one or more prior positions of the lane boundary of the one or more lane boundaries, wherein the cost is proportional to a pixel distance in the image between the one or more positions of the lane boundary and the one or more prior positions of the lane boundary of the one or more lane boundaries divided by a width of the image.

Aspect 24. The method of any one of aspects 17 to 23, further comprising determining the one or more positions of the lane boundary within the image based on a plurality of images.

Aspect 25. The method of any one of aspects 17 to 24, further comprising tracking, using a Kalman filter, the one or more positions of the lane boundary within the image based on a plurality of images.

Aspect 26. The method of any one of aspects 17 to 25, further comprising updating tracked positions of the one or more positions of the lane boundary based on the image.

Aspect 27. The method of any one of aspects 17 to 26, wherein determining the distance between the target vehicle and the lane boundary comprises determining a distance between the target vehicle and a point of the lane boundary between the one or more positions of the lane boundary.

Aspect 28. The method of any one of aspects 17 to 27, further comprising tracking the distance between the target vehicle and the lane boundary over a plurality of images.

Aspect 29. The method of any one of aspects 17 to 28, further comprising tracking, using a Kalman filter, the distance between the target vehicle and the lane boundary over a plurality of images.

Aspect 30. The method of any one of aspects 17 to 29, further comprising obtaining the image and determining the position of the target vehicle within the image.

Aspect 31. The method of any one of aspects 17 to 30, further comprising determining the position of the target vehicle within the image based on a plurality of images.

Aspect 32. The method of any one of aspects 17 to 31, further comprising determining a bounding box associated with the target vehicle based on a plurality of images and determining the position of the target vehicle based on the bounding box.

Aspect 33. A non-transitory computer-readable storage medium having stored thereon instructions that, when executed by at least one processor, cause the at least one processor to perform operations according to any of aspects 17 to 32.

Aspect 34. An apparatus for providing virtual content for display, the apparatus comprising one or more means for perform operations according to any of aspects 17 to 32.

What is claimed is:

1. An apparatus for determining at least one location of at least one target vehicle relative to a lane, the apparatus comprising:
at least one memory; and
at least one processor coupled to the at least one memory and configured to:
obtain a position of a target vehicle within an image;
obtain one or more positions of a lane boundary within the image;
determine a distance between the target vehicle and the lane boundary based on the position of the target vehicle within the image and the one or more positions of the lane boundary within the image; and
adjust a position of the target vehicle in a map based on the distance between the target vehicle and the lane boundary and a position of the lane boundary in the map.

2. The apparatus of claim 1, wherein the at least one processor is further configured to perform an operation, wherein the operation is at least one of:
planning a path of a tracking vehicle based on the map; or
controlling the tracking vehicle based on the map.

3. The apparatus of claim 1, wherein the at least one processor is further configured to determine a lane association of the target vehicle based on the distance between the target vehicle and the lane boundary.

4. The apparatus of claim 3, wherein the at least one processor is further configured to control a tracking vehicle based, at least in part, on the lane association of the target vehicle.

5. The apparatus of claim 1, wherein, to determine the distance between the target vehicle and the lane boundary, the at least one processor is further configured to determine a distance between a center point of a bottom plane of a bounding box of the target vehicle and the lane boundary.

6. The apparatus of claim 1, wherein the at least one processor is further configured to:
obtain one or more prior positions of one or more lane boundaries determined based on one or more prior images; and
associate the one or more positions of the lane boundary with one or more prior positions of a lane boundary of the one or more lane boundaries.

7. The apparatus of claim 6, wherein the at least one processor is further configured to determine a cost of associating the one or more positions of the lane boundary with the one or more prior positions of the lane boundary of the one or more lane boundaries, wherein the cost is proportional to a pixel distance in the image between the one or more positions of the lane boundary and the one or more prior positions of the lane boundary of the one or more lane boundaries divided by a width of the image.

8. The apparatus of claim 1, wherein the at least one processor is further configured to determine the one or more positions of the lane boundary within the image based on a plurality of images.

9. The apparatus of claim 1, wherein the at least one processor is further configured to track, using a Kalman filter, the one or more positions of the lane boundary within the image based on a plurality of images.

10. The apparatus of claim 1, wherein the at least one processor is further configured to update tracked positions of the one or more positions of the lane boundary based on the image.

11. The apparatus of claim 1, wherein, to determine the distance between the target vehicle and the lane boundary, the at least one processor is further configured to determine a distance between the target vehicle and a point of the lane boundary between the one or more positions of the lane boundary.

12. The apparatus of claim 1, wherein the at least one processor is further configured to track the distance between the target vehicle and the lane boundary over a plurality of images.

13. The apparatus of claim 1, wherein the at least one processor is further configured to track, using a Kalman filter, the distance between the target vehicle and the lane boundary over a plurality of images.

14. The apparatus of claim 1, wherein the at least one processor is further configured to obtain the image and determine the position of the target vehicle within the image.

15. The apparatus of claim 1, wherein the at least one processor is further configured to determine the position of the target vehicle within the image based on a plurality of images.

16. The apparatus of claim 1, wherein the at least one processor is further configured to determine a bounding box associated with the target vehicle based on a plurality of images and determine the position of the target vehicle based on the bounding box.

17. A method for determining at least one location of at least one target vehicle relative to a lane, the method comprising:
obtaining a position of a target vehicle within an image;
obtaining one or more positions of a lane boundary within the image;
determining a distance between the target vehicle and the lane boundary based on the position of the target vehicle within the image and the one or more positions of the lane boundary within the image; and
adjusting a position of the target vehicle in a map based on the distance between the target vehicle and the lane boundary and a position of the lane boundary in the map.

18. The method of claim 17, further comprising an operation, wherein the operation is at least one of:
planning a path of a tracking vehicle based on the map; or
controlling the tracking vehicle based on the map.

19. The method of claim 17, further comprising determining a lane association of the target vehicle based on the distance between the target vehicle and the lane boundary.

20. The method of claim 19, further comprising controlling a tracking vehicle based, at least in part, on the lane association of the target vehicle.

21. The method of claim 17, wherein determining the distance between the target vehicle and the lane boundary comprises determining a distance between a center point of a bottom plane of a bounding box of the target vehicle and the lane boundary.

22. The method of claim 17, further comprising:
obtaining one or more prior positions of one or more lane boundaries determined based on one or more prior images; and
associating the one or more positions of the lane boundary with one or more prior positions of a lane boundary of the one or more lane boundaries.

23. The method of claim 22, further comprising determining a cost of associating the one or more positions of the lane boundary with the one or more prior positions of the lane boundary of the one or more lane boundaries, wherein the cost is proportional to a pixel distance in the image between the one or more positions of the lane boundary and the one or more prior positions of the lane boundary of the one or more lane boundaries divided by a width of the image.

24. The method of claim 17, further comprising determining the one or more positions of the lane boundary within the image based on a plurality of images.

25. The method of claim 17, further comprising tracking, using a Kalman filter, the one or more positions of the lane boundary within the image based on a plurality of images.

26. The method of claim 17, further comprising updating tracked positions of the one or more positions of the lane boundary based on the image.

27. The method of claim 17, wherein determining the distance between the target vehicle and the lane boundary comprises determining a distance between the target vehicle and a point of the lane boundary between the one or more positions of the lane boundary.

28. The method of claim 17, further comprising tracking, using a Kalman filter, the distance between the target vehicle and the lane boundary over a plurality of images.

29. The method of claim 17, further comprising obtaining the image and determining the position of the target vehicle within the image.

30. The method of claim 17, further comprising determining a bounding box associated with the target vehicle based on a plurality of images and determining the position of the target vehicle based on the bounding box.
